(19) United States
(12) Patent Application Publication
(10) Pub. No.: US 2010/0144411 A1
(43) Pub. Date: Jun. 10, 2010

(54) Touch Tarp for Mobile Devices

(76) Inventor: Bernard Frances Pettingill, Palm Beach Gardens, FL (US)

Correspondence Address: Bernard Pettingill, #93 Sandbourne Lane, Palm Beach Gardens, FL, 33418, US

(21) Appl. No.: 12/331,629

(22) Filed: Dec. 10, 2008

(51) Int. Cl. H04M 1/00

(52) U.S. Cl. 455/575.8

(57) ABSTRACT

Touch Tarp for Mobile Devices will secure a mobile device into a case by sliding it up from the bottom and locking it in. With the explosion of touch screen mobile devices, it will help to safely and securely hold mobile devices to prevent accidental calling and/or damage to the mobile device. It can be quickly utilized to access the mobile device by lifting the slider cover either up or down and adapted to various mobile devices, such as iPod™, PDA's, Mobile PC, etc.

### FIELD OF THE INVENTION

The present invention relates to safety, security, accidentally calling a number or an embarrassing call back and damaging an expensive mobile device. The casing will provide a protective cover, which can be quickly utilized to access the device by lifting the slider screen either up or down.

### BACKGROUND OF THE INVENTION

In the last few years, there has been an explosion in touch screen mobile devices. Unfortunately, the screen is so sensitive that after the device is used, it does not always lock or deactivate following use and the incident of accidentally calling a number or an embarrassing call back is on the rise. In addition, the screen can be damaged on these increasingly expensive devices. With escalating travel and widespread utilization of these devices, this problem will only intensify as individuals utilize their devices at airports, train stations, colleges, medical offices and hotels. In addition, with longer battery life and wait times around the world on the rise (i.e. waiting for a plane or doctor's appointment), quick safety and security will also be a factor.

Individuals currently use purses, pockets or belt holders, but none protect the device from inadvertently being touched quickly after device use. These mobile devices with touch screens must be deactivated or an individual must wait until the device deactivates prior to storing; if not, an individual can suffer the embarrassing consequences of an unexpected call back. In today's busy society, no one has the time to deactivate the phone (usually a multi-step process) and with the present embodiment, the slider cover can quickly be slid up or down after or prior to usage.

Attempts have been made to provide a solution with stick on covers, but no one is offering a slider cover for quick and easy access. With all the various arrangements of shapes and materials in telephone covers, the basic requirements of quick and easy access are still unmet.

### SUMMARY OF THE INVENTION

The mobile device cases/covers of the present invention are unique. They are designed to prevent damage and promote safety/security for inexpensive to expensive devices. The slider cover allows for quick up/down access. These cases are made in a variety of configurations and each case may be adapted to various mobile devices, such as iPod™, PDA, Mobile PC, etc. The covers are easily opened and closed with one hand, and come in various colors. The cases are made of bacterial resistant material to also prevent the spread of germs and may also be made of a fluid resistant material.

By using our specially designed case, the user helps prevent damaging their device and prevents embarrassing call backs with the potential loss of trade and family secrets. Also, there is no degradation of the voice transmission when using the case with slider cover of the present invention.

For example: An individual calls for car service and speaks with someone about picking up their car. The individual is told the car will not be ready until the next day, when it was promised today. The individual acknowledges to the service technician that he will pick-up the car in the a.m. and hangs up. Unfortunately, he did not protect the device and when put in his pocket it called the service shop back (accidentally). When the service technician picks up the phone to answer the call, he hears the individual talking with his wife about the poor service and how the shop never lives up to their word. This upsets the service technician and what happens next we will never know. The next morning the individual goes to pick-up his car and the technician says, “I found additional problems and will need the car a few more days, I will let you know how much it will cost tomorrow”. If only there was never the accidental call back this would not have happened. Touch Tarp for Mobile Devices will address these issues and more.

### DETAILED DESCRIPTION OF THE PREFERRED EMBODIMENTS

FIG. 5 illustrates the front of the mobile device with the case open. The slider cover may then be quickly lowered to protect the device without waiting for the touch screen to become deactivated. FIG. 6 now shows the case closed. FIG. 7 shows the mobile device from the side with the case open and how it can be held. FIG. 8 shows the same device with the case closed. FIG. 9 is a bottom view with the case open and the bottom closure open to show the mobile device. Finally, FIG. 10 shows the same device with the case closed and the bottom open again to show the device.

While the foregoing has described what are considered to be example embodiments, it is understood that various modifications may be made therein and that the invention may be implemented in various forms and embodiments, and that it may be applied in numerous ways, some of which have been described herein.

### BRIEF DESCRIPTION OF THE DRAWINGS

Numbers 1 are the slider closures made of a flexible material to go over device; it is shown on the various views of FIG. 5 to 10.

Numbers 2 are the bottom closures hinged to the case (Number 4) with snap or Velcro to hold shut; it is shown on the various views of FIG. 5 to 10.

Numbers 3 are the handles to help slide the covers to facilitate opening and closing of the slider cover: it is shown on the various views of FIG. 5 to 10.

Numbers 4 are the cases to hold the devices; it is shown on the various views of FIG. 5 to 10.

FIG. 5 is a Front View of the Touch Tarp (Case Open) with all the various Numbers noted on drawings.

FIG. 6 is a Front View of the Touch Tarp (Case Closed) with all the various Numbers noted on drawings.

FIG. 7 is a Side View of the Touch Tarp (Case Open) with all the various Numbers noted on drawings.

FIG. 8 is a Side View of the Touch Tarp (Case Closed) with all the various Numbers noted on drawings.

FIG. 9 is a Bottom View of the Touch Tarp (Case Open) with all the various Numbers noted on drawings.

FIG. 10 is a Bottom View of the Touch Tarp (Case Closed) with all the various Numbers noted on drawings.

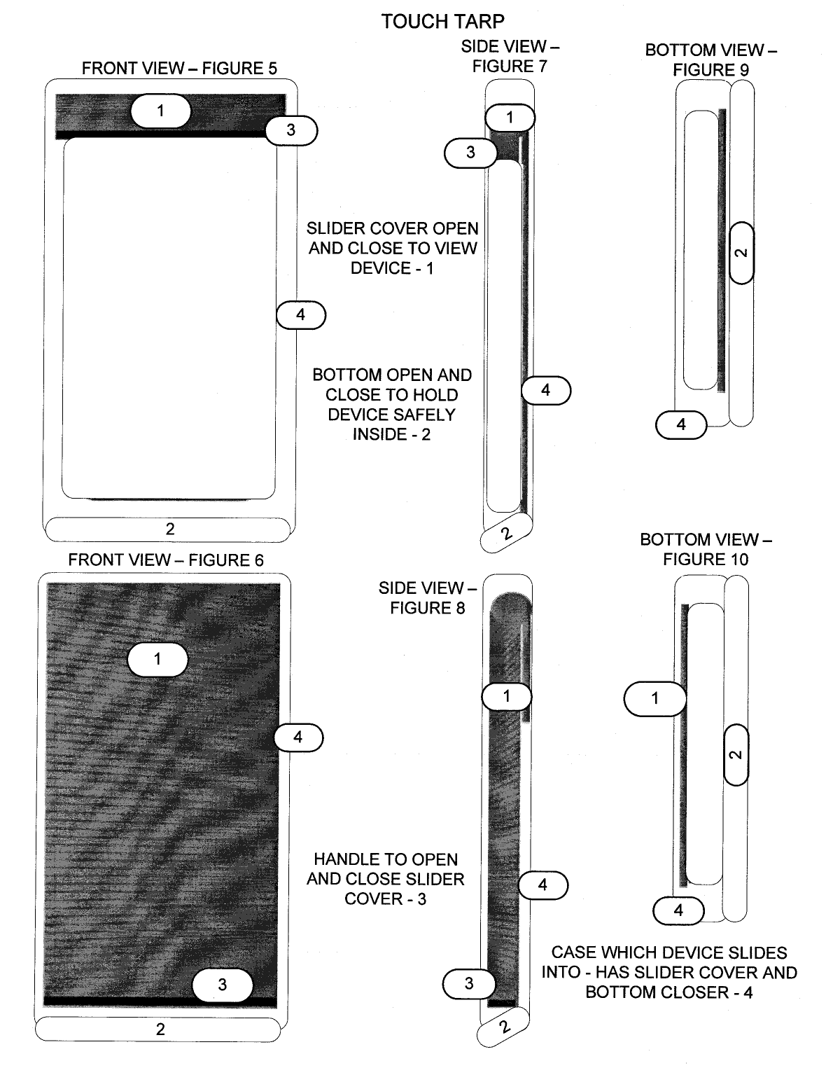

1. A safety cover for mobile devices comprising: a case, slider cover and closure bottom, made of plastic, leather or other material.

2. A method for holding and securing a device into a case by sliding up from the bottom and locking it in with a Velcro or snap closure bottom.
